(19) United States
(12) Patent Application Publication
(10) Pub. No.: US 2015/0097023 A1
(43) Pub. Date: Apr. 9, 2015

(54) PROCESS FOR JOINING TWO METAL PARTS BY BRAZE-WELDING

(71) Applicant: SNECMA, Paris (FR)

(72) Inventor: Jean-Francois Didier Clement, Yerres (FR)

(73) Assignee: SNECMA, Paris (FR)

(21) Appl. No.: 14/382,119

(22) PCT Filed: Feb. 27, 2013
(86) PCT No.: PCT/FR2013/050410

§ 371 Date: Aug. 29, 2014

(30) Foreign Application Priority Data
Mar. 2, 2012 (FR) 1251962

(51) Int. Cl. B23K 1/19; B23K 35/36; B23K 35/30; B23K 1/20; B23K 1/00

(52) U.S. Cl. CPC B23K 1/19; B23K 1/203; B23K 1/0018; B23K 35/3033; B23K 35/3046; B23K 35/3026; B23K 35/302; B23K 35/3006; B23K 35/3013; B23K 35/3606; B23K 35/3607; B23K 35/3611
USPC 228/214; 228/101; 228/258

(57) ABSTRACT

A process for joining two parts by braze-welding, including forming a joint, between two surfaces to be joined, and a fillet. The composition of the filler metal used to form the fillet is different from that used to form the joint, to provide the joint with a higher ductility. The method can, for example, be applied to production of high-pressure compressor guide-vane sectors for a turbomachine.

### FIELD OF THE INVENTION

The present invention relates to the brazing of parts made of a nickel-based or cobalt-based superalloy, that is to say made of a refractory alloy having a content by weight of at least 50% nickel or cobalt respectively, in particular in the field of aeronautics.

### PRIOR ART

In aeronautical gas turbine engines numerous parts are produced by mechanical brazing. Brazing involves placing a bonding metal layer between the bonding faces of the metal parts to be joined, which metal layer has a similar composition to said parts, although comprises an element, known as “the flux”, which makes said layer more meltable than the alloys of the parts to be joined. The melting metal may be added by capillary action along the bonding gap, thus forming a capillary joint. A “capillary joint” is a joint obtained in a space of approximately 200 μm between the parts for brazing.

Patent FR 2 896 175, held by the present applicant, describes an improved filler metal composition for forming a bonding joint between two superalloy parts, as well as the method for brazing turbine engine stator vane sectors using this type of filler metal.

High-pressure compressor stator vane sectors are formed of vanes which are forged as units and brazed onto upper and lower collars. These parts are made of a nickel-based or cobalt-based wrought alloy, such as the alloy known as “INCO718” of the formula NC19FeNb. The filler metals used for brazing the parts to each other are alloys, which are also nickel-based if the metal of the alloy is nickel, containing boron and/or silicon as the flux element. The brazes obtained with this type of alloy are very effective in capillary joints.

Positioning of the parts in the joint may require formation of a fillet as an extension to the bonding joint, in the form of an arc of circle-shaped rounded concave moulding located between the two adjacent faces of the joint. When the parts comprise a fillet, the mass of the filler metal may be significant. It has been found that in this case, the filler metal masses were of a fragile nature. Indeed, nickel-based melted filler metals with silicon and boron have very low ductility and crack when subjected to low-amplitude deformations. FIG. 1 shows the micrographic cut of a joint produced by brazing two parts 2 and 4 using this technique. The parts are joined and bonded to each other by a capillary brazed joint 3. A fillet 5 has been produced between the two parts as an extension of the joint, by adding a melted metal which is the same metal as that of the joint. The joint has then been subjected to fatigue tests. It can be seen that the joint 3 has remained intact, whereas the fillet, which has a thickness of over 0.5 mm and so is of a larger size than the joint, has cracked under the effect of the stress caused by the deformation forces.

This crack 7, which started in the filler metal mass 5, only very rarely spreads into the brazed capillary joint 3 because said joint is generally flanged and comes under less mechanical stress. By contrast, under the notch effect, entailing a concentration of stress, this crack may spread into the single-layer base metal.

To avoid this problem of cracks appearing in the braze fillets, solutions are known for joining stator vane sectors, yet although said solutions have been applied, they are not yet widespread. Said solutions involve:
use of an effective filler metal for the whole of the braze, such as a gold-based alloy, in particular AuNi955, which contains 82% gold;
machine-cutting the collar made of INCO718 to provide flexibility and reduce the stress on the vane-collar radius blends.

Understandably, the above two solutions are little used on account of the prohibitive cost arising in the first case because a precious metal is used and in the other case because of the cost of machining the collar in stressed regions close to the braze fillets. This machining is also likely to create air leaks in the seam and to weaken the cut collars.

### SUMMARY OF THE INVENTION

The present invention relates to a method for producing a joint that is free from the drawbacks of the prior art and which is less costly than existing solutions.

The method, according to the invention, for joining two parts by brazing and comprising the formation of a bonding joint between two bonding surfaces and of a fillet is characterised in that the chemical composition of the filler metal for forming the fillet is different from that of the bonding joint, so as to have greater ductility.

The proposed solution is thus to use two fillers metals. This solution gives rise to two specific types of behaviour: high traction performance together with low ductility for the bonding joint, and satisfactory ductility at the fillet connecting the two joined parts. The bonding joint is preferably a capillary joint.

Using a ductile alloy to form the fillet prevents the local formation of cracks in a, simple manner.

According to another feature, the brazing temperature for the fillet is lower than the liquidus temperature of the metal of the bonding joint.

The invention is advantageous in joining nickel-based or cobalt-based superalloy parts. More particularly, the filler metal for forming the bonding joint is either a nickel-based or cobalt-based alloy having at least one flux compound. The flux compound is selected from among boron, silicon and phosphorous. For example, boron combined with silicon is one widely used flux.

Advantageously, the filler metal forming the fillet is a copper-based alloy, such as CuMnNi930, a manganese-based alloy or an alloy based on a precious metal, such as gold.

An advantageous application of the invention is in the production of stator vane sectors, one part being at least one turbine engine compressor vane and the other part a collar.

### BRIEF DESCRIPTION OF THE DRAWINGS

FIG. 1 is a micrographic cut of a joint of the prior art.

FIG. 2 is a schematic view of the formation of a bonding joint between two superalloy metal parts according to the first step of the method.

FIG. 3 shows the formation of a fillet in the second step of the method of the invention.

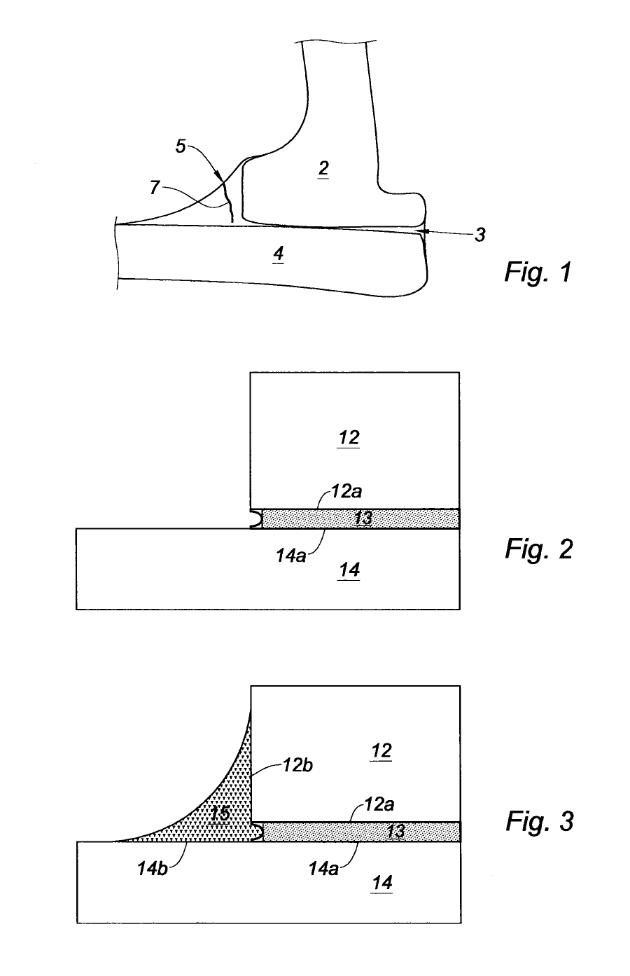

### DETAILED DESCRIPTION OF AN EMBODIMENT OF THE INVENTION

FIG. 2 is a cross section of the two superalloy parts 12 and 14, as marketed under the name “INCO718”. The two parts are bonded to each other by a bonding joint 13 along a gap made between two bonding faces, 12a and 12b, of the one and the other part. To produce a stator vane sector for a turbine engine compressor, the first part 12 is a stator vane and the second part 14 is a collar element.

Advantageously, the bonding joint is a capillary joint having a thickness of less than 200 μm. The first braze filler metal used for this first braze is advantageously, in this case, a nickel base of the nickel-chromium type with boron and/or silicon added as the flux element. It can be seen that there is a small fillet between the two parts.

This type of filler alloy produces capillary brazed joints having a similar tensile and shear strength to that of the base metal of the parts.

In the second step, a second filler metal is placed between two faces 12b and 14b of the parts, beyond the bonding joint. The fillet 15 that is obtained has an arc of circle-shaped surface linking the two faces 12b and 14b at a tangent to each of these two surfaces.

A ductile filler metal is used for this second brazing operation and to produce the braze fillets.

Moreover, said operation is performed at a temperature below the liquidus temperature of the first alloy used as the filler metal for the bonding joint. The ductility of the filler metal prevents cracks from appearing in the fillet during deformation of the second part 14. Indeed, the second part, which is a collar in this case, has a relatively low thickness compared with the first part and is likely to deform first.

As regards the assembly of an HP compressor diffuser, the materials present are a nickel-based alloy of formula NC19FeNb (INCO718) and a first filler metal of formula NiCrBSi1000. Brazing of the bonding joint is performed at a temperature of 1040° C.

Then, in a new brazing operation, the temperature increases to 960° C. in order to produce the external hard-face of the joint and to create a fillet using the second filler metal, the composition of which has been selected for its ductility, for example a copper-based alloy of formula CuMnNi930.

1-9. (canceled)

10. A method for joining two metal parts by brazing, comprising:
forming, by a filler metal, a bonding joint between two bonding surfaces and a fillet,
wherein the chemical composition of the filler metal for forming the fillet is different from that of the bonding joint, to have greater ductility.

11. A method according to claim 10, wherein the bonding joint is a capillary joint.

12. A method according to claim 10, wherein brazing temperature for the fillet is lower than liquidus temperature of the filler metal of the bonding joint.

13. A method according to claim 10, wherein the two metal parts are made of either a nickel-based or cobalt-based superalloy.

14. A method according to claim 13, wherein the filler metal for forming the bonding joint is either a nickel-based or cobalt-based alloy including at least one flux compound.

15. A method according to claim 14, wherein the flux compound is at least one element from among boron, silicon, and phosphorus.

16. A method according to claim 10, wherein the filler metal of the fillet is a copper-based alloy, or CuMnNi930, or a manganese-based alloy, or a precious-metal alloy.

17. A method according to claim 10, wherein one part of the two metal parts is a turbine engine compressor blade and the other part is a collar.

18. A method according to claim 17, wherein the joining forms a stator vane sector.
